(19) United States
(12) Patent Application Publication
(10) Pub. No.: US 2013/0079187 A1
(43) Pub. Date: Mar. 28, 2013

(54) COMPOSITE RAMP PLATE FOR ELECTRONICALY-ACTUATED LOCKING DIFFERENTIAL

(71) Applicant: Andrew N. Edler, Homer, MI (US)

(72) Inventor: Andrew N. Edler, Homer, MI (US)

(21) Appl. No.: 13/247,455

(22) Filed: Sep. 28, 2011

(51) Int. Cl. F16H 48/34; B22F 7/02; F16D 19/00; B23P 17/04

(52) U.S. Cl. 475/150; 192/93 R; 29/527.5; 419/6

(57) ABSTRACT

A cam member for a vehicle differential includes a cam surface made of a high-durability alloy and a clutch surface made of a high-density magnetic alloy. The cam surface and the clutch surface can either be formed into a single component or as separate components that are mechanically coupled together. In one aspect, both the high-durability alloy and the high-density magnetic alloy are powdered metal alloys. As a result, the cam member has different surfaces with optimized characteristics that would ordinarily be difficult to incorporate into a single component.

### TECHNICAL FIELD

The present teachings relates to electronically actuated locking differentials, and more particularly to a component in such a differential that is made as a composite part.

### BACKGROUND

The present teachings generally include limited slip and locking differentials in vehicles typical include a gear housing and a differential gear set including at least one input pinion gear and a pair of output side gears disposed within the housing. A clutch can be disposed between one of the side gears and an adjacent surface of the gear housing so that the clutch can retard or prevent rotation between the side gears and the gear case when it is engaged.

An actuating mechanism biases the clutch to its engaged condition. Electronic actuation mechanisms, which engage the clutch in response to an electrical signal (e.g., a microprocessor-generated signal), typically include an electromagnetic coil. One type of electronically actuated differential uses an electromagnetically actuated clutch to create relative motion between a cam member and a differential case. The relative motion creates axial movement that meshes a locking collar with side gears to lock the differential.

In some differential systems, the cam member itself may be a cam plate having a clutch surface that engages with the electromagnetic clutch and a cam surface that engages with a corresponding cam surface on the differential case or other component. This, the clutch surface should have excellent magnetic hysteresis properties, such as high tractive force and low coercive force to ensure good locking and unlocking performance, while the cam surface should have high durability to resist wear and impact.

### SUMMARY

A cam member for a vehicle differential according to one aspect of the present teachings includes a cam surface made of a high-durability alloy and a clutch surface made of a high-density magnetic alloy. The cam surface and the clutch surface can either be formed into a single component or as separate components that are mechanically coupled together. In one aspect of the present teachings, both the high-durability alloy and the high-density magnetic alloy are powdered metal alloys.

Another aspect of the present teachings is directed to a method of manufacturing such a cam member. As a result, the cam member has different surfaces with optimized characteristics that would ordinarily be difficult to incorporate into a single component.

### BRIEF DESCRIPTION OF THE DRAWINGS

FIG. 1 is an exploded view of a vehicle differential incorporating a cam member according to one aspect of the present teachings.

FIG. 2 is an exploded view of the vehicle differential in FIG. 1 taken from another view to show the clutch portion.

FIG. 3 is a side view of the cam member shown in FIGS. 1 and 2.

FIG. 4 is a flow diagram illustrating a process used to make the cam member in FIG. 3 in accordance with one aspect of the present teachings.

FIG. 5 is a side view of a cam member according to another aspect of the present teachings.

### DETAILED DESCRIPTION

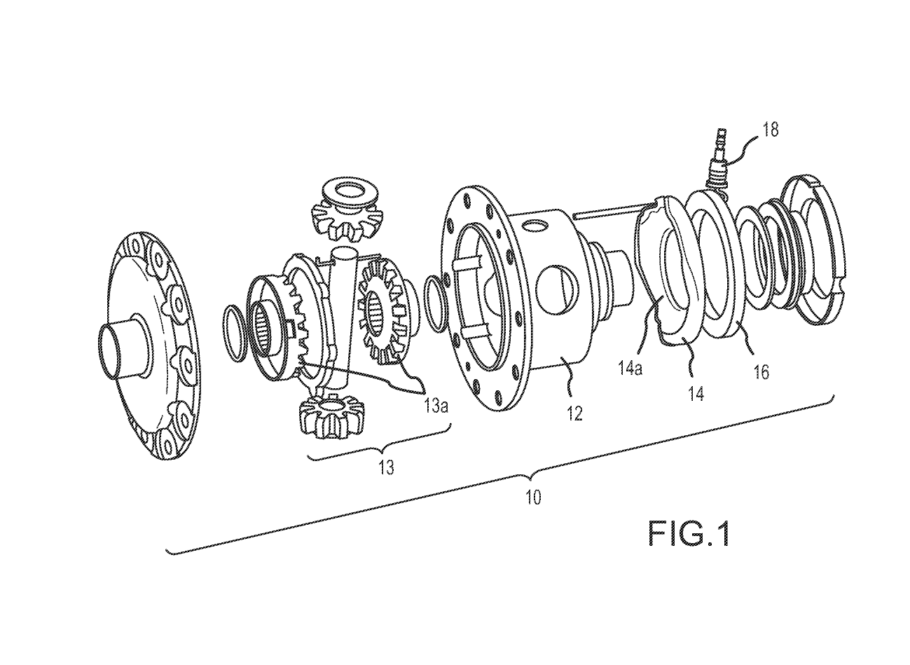

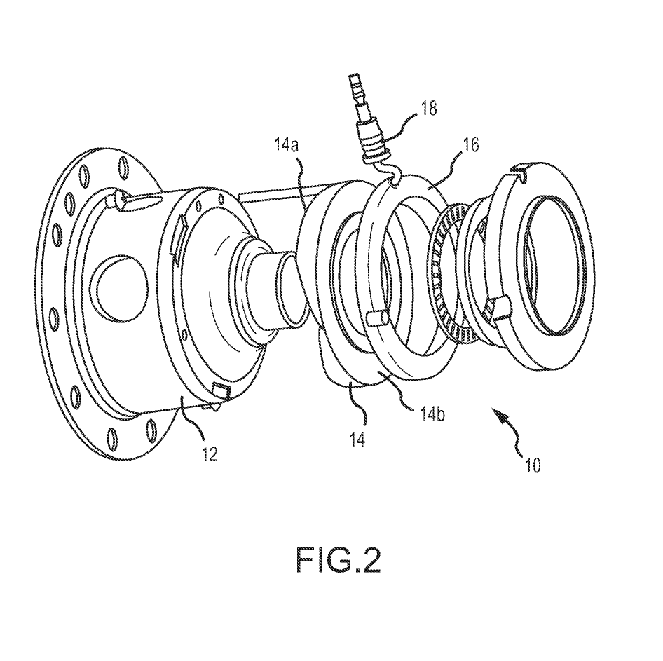

FIGS. 1 and 2 are exploded views of an engagement portion of a vehicle differential 10 illustrating aspects of the present teachings. The differential 10 includes a differential case 12, which houses a gear mechanism 13, and a cam member 14. The cam member 14 can have a cam surface 14a facing the differential case 12 and a clutch surface 14b on the opposite side. During normal, straight-ahead vehicle operation, the cam member 14 can rotate together with the differential case 12. The cam surface 14 is configured to ramp or otherwise engage with the differential case 12 or other engagement member when there is relative rotation between the cam member 14 and the differential case 12. The relative rotation can move the differential case 12 axially to lock a locking mechanism via side gears 13a in the differential 10.

The differential 10 also includes an electromagnet 16 disposed adjacent to the clutch surface 14b. The electromagnet 16 includes a connector 18 that links the electromagnet 16 with a signal source (not shown). The electromagnet 16 can energize and de-energize in response to an electrical signal. When the electromagnet 16 is energized in response to an electrical signal, it can generate a magnetic field that can attract the clutch surface 14b of the cam member 14 toward the electromagnet 16, creating a magnetic drag that can slow rotation of the cam member 14 relative to the differential case 12. This creates the relative rotation between the cam member 14 and the differential case 12. The relative rotation can cause the cam surface 14a to ramp against the differential case 12 and create axial movement that can push the side gear 13a into a locking position, thereby locking the differential 10.

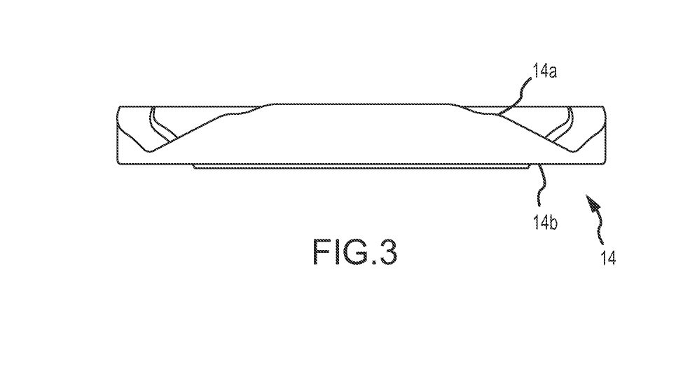

Because the cam surface 14a and clutch surface 14b serve such different functions, the cam member 14 according to one aspect of the present teachings can have the cam surface 14a and the clutch surface 14b made of different materials, as shown in FIG. 3. More particularly, the cam surface 14a can be made of a material chosen for high durability and the clutch surface 14b can be made of a material chosen for excellent magnetic hysteresis properties. The desired characteristics for both the clutch surface and the cam surface are difficult to find in a single material. Low carbon alloys have good magnetic hysteresis, low coercive force, and high tractive force, but low carbon alloys tend to have lower durability. Increasing the overall carbon content in the cam plate and/or heat-treating the cam plate to increase the carbon content at the surface can increase the hardness of the cam surface, but these changes compromise the magnetic properties of the cam plate as well.

The cam member according to one aspect of the present teachings has a clutch surface with good magnetic properties and a cam surface with high durability without requiring performance compromises on either surface.

To form the cam member 14 out of two different materials, the cam member 14 can be made out of powdered metal. In one aspect of the present teachings, the cam surface 14a portion of the cam member 14 can be made of a durable sinter-hardenable powdered metal alloy, such as high-carbon metal alloys, such as FLN2-4408 or FLC-4908. In one aspect, the percentage of carbon in the alloy can be around 0.8%, such as in a range from 0.7% to 0.9% carbon content. The clutch surface 14b portion can be made of a high-density magnetic alloy. In one aspect, the high-density magnetic alloy can contain little or no carbon, such as less than 0.2% carbon content. Using a sinter-hardenable alloy on the cam surface 14a can be shown to eliminate the need to harden the cam member 14 by placing it in a carbon-rich environment, thereby avoiding the problem of also driving additional carbon into the clutch surface 14b during the hardening process and decreasing its magnetic performance.

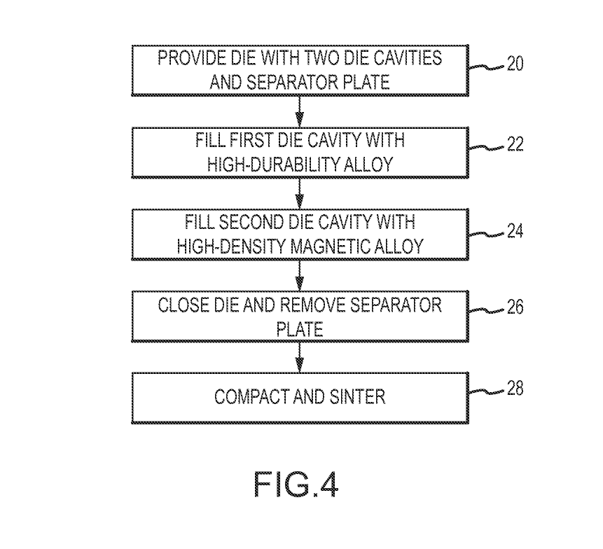

FIG. 4 is a flow diagram illustrating a method for manufacturing the cam member 14 according to another aspect of the present teachings. In block 20, the method can include providing a die with two die cavities and a separator plate between them. In block 22, one die cavity can be filled with the high-durability alloy for the cam surface 14a. In block 24, the other die cavity can be filled with the high-density magnetic alloy for the clutch surface 14b. In block 26, the die can then be closed and the separator plate can be removed. In block 28, the cam member 14 can be compacted and sintered 28 to form the cam member 14 as a single, unitary piece. The resulting cam member 14 can be shown to have relatively optimal performance requirements for both the cam surface 14a and the clutch surface 14b despite the different metallurgical characteristics of each surface.

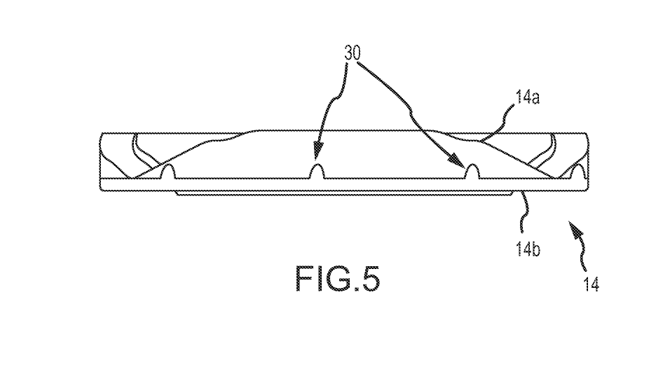

FIG. 5 illustrates a cam member 14 constructed in accordance with another aspect of the present teachings. In this aspect, the cam surface 14a and the clutch surface 14b can be formed as two separate pieces. The cam surface 14a and the clutch surface 14b can be mechanically coupled together via engagement surfaces, such as splines 30, tabs, an interference fit, or other structures. The mechanical coupling can transfer torque from the clutch surface 14b to the cam surface 14a when the electromagnet 16 is energized.

It will be appreciated in light of the disclosure that the cam member 14 in FIG. 5 does not need to be formed via powder metallurgy and can be formed via any other manufacturing method. Since the cam surface 14a and the clutch surface 14b are mechanically coupled and do not need to be bonded together like the embodiment in FIG. 3, any appropriate manufacturing method can be used to make the cam surface 14a and clutch surface 14b.

As a result, the two different materials forming the composite cam member 14 can have different surfaces that can be shown to be relatively optimized for different requirements. The present teachings therefore can provide cost-effective manufacturing methods, such as powdered metal technology and sinter hardening heat treatment.

It will be appreciated that the above teachings are merely exemplary in nature and is not intended to limit the present teachings, their application or uses. While specific examples have been described in the specification and illustrated in the drawings, it will be understood by those of ordinary skill in the art that various changes may be made and equivalents may be substituted for elements thereof without departing from the scope of the present teachings as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present teachings not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. A cam member for a vehicle differential, comprising:
a cam surface made of a high-durability alloy; and
a clutch surface made of a high-density magnetic alloy.

2. The cam member of claim 1, wherein the high-durability alloy is a sinter-hardenable powdered metal alloy.

3. The cam member of claim 1, wherein the high-durability alloy is a high-carbon alloy.

4. The cam member of claim 3, wherein the high-durability alloy has a carbon content between 0.7% and 0.9%.

5. The cam member of claim 1, wherein the high-density magnetic alloy is a powdered metal alloy.

6. The cam member of claim 1, wherein the high-density magnetic alloy has a carbon content no greater than 0.2%.

7. The cam member of claim 1, wherein the cam surface and the clutch surface are formed as separate pieces that are mechanically coupled together.

8. A vehicle differential, comprising:
a differential case;
a gear mechanism including a locking mechanism and at least one side gear, wherein the locking mechanism is engageable with the side gear to lock the differential;
a cam member having a cam surface and a clutch surface, wherein the cam surface is engageable with the differential case to axially move the differential case and lock the locking mechanism upon relative rotation between the cam member and the differential case; and
an electromagnet disposed adjacent to the cam surface,
wherein the cam surface of the cam member is made of a high-durability alloy and the clutch surface of the cam member is made of a high-density magnetic alloy.

9. The vehicle differential of claim 8, wherein both the high-durability alloy and the high-density magnetic alloy are powdered metal alloys.

10. The vehicle differential of claim 8, wherein the high-durability alloy in the cam surface is a high-carbon sinter-hardenable powdered metal alloy.

11. The vehicle differential of claim 8, wherein the high-durability alloy has a carbon content between 0.7% and 0.9%.

12. The vehicle differential of claim 8, wherein the high-density magnetic alloy has a carbon content no greater than 0.2%.

13. The vehicle differential of claim 8, wherein the cam surface and the clutch surface of the cam member are formed as separate pieces that are mechanically coupled together.

14. A method of manufacturing a cam member for a vehicle differential, comprising:
providing a die cavity having a first half and a second half;
placing a high-durability alloy in the first half to form a cam surface;
placing a high-density magnetic alloy in the second half to form a clutch surface; and
mechanically coupling the cam surface and the clutch surface to form the cam member.

15. The method of claim 14, wherein the step of mechanically coupling comprises closing the die cavity to bring the first half and the second half together to form the cam member as a single unit.

16. The method of claim 15 further comprising:
placing a separator plate between the first and second halves; and
removing the separator plate after the closing step.

17. The method of claim 14, further comprising:
compacting the first and second halves together; and
sintering the cam member to form the cam member as the single unit.

18. The method of claim 14, wherein the high-durability alloy and the high-density alloy are powdered metal alloys.

19. The method of claim 14, further comprising the step of providing engagement surfaces on the cam member and the clutch member, and wherein the step of mechanically coupling comprises engaging the engagement surfaces of the cam member and the clutch member.
